(19) United States
(12) Patent Application Publication
(10) Pub. No.: US 2017/0306641 A1
(43) Pub. Date: Oct. 26, 2017

(54) THREE-DIMENSIONAL CIRCULATING GARAGE

(71) Applicant: BYD COMPANY LIMITED, Shenzhen (CN)

(72) Inventors: Tian QI, Shenzhen (CN); Jinghua TANG, Shenzhen (CN)

(21) Appl. No.: 15/505,307

(22) PCT Filed: Sep. 14, 2015
(86) PCT No.: PCT/CN2015/089558

§ 371 Date: Feb. 21, 2017

(30) Foreign Application Priority Data
Sep. 15, 2014 (CN) 201410469382.2

(51) Int. Cl. E04H 6/14; B60L 11/18

(52) U.S. Cl. CPC E04H 6/14; B60L 11/1809

(57) ABSTRACT

A three-dimensional circuiting garage is provided. The three-dimensional circulating garage includes: a fixing frame including a first fixing support and a second fixing support; a transmission system including a transmission device disposed on the fixing frame, and a tray track disposed on at least one of the first and second fixing supports; a plurality of tray units each including; a tray frame, a vehicle carrying plate, and a tray stabilizing beam; and a driving device connected with the transmission device to drive the transmission device so as to drive the tray unit to move up and down reciprocally in a cyclical manner along the tray track; wherein when two adjacent tray units move in a vertical direction, a lower surface of the vehicle carrying plate of an upper tray unit is supported on the tray stabilizing beam of a lower tray unit.

### FIELD

The present disclosure generally relates to a field of garage and, particularly, relates to three-dimensional circulating garage.

### BACKGROUND

In the related art, since the current vertical three-dimensional circulating garage includes a lower guiding wheel of the tray and a guiding wheel rail, a vehicle stored in the vertical three-dimensional circulating garage cannot run straight. That is, the vehicle should be driven in forward and then be driven out backward, or the vehicle should be driven in backward and then be driven out forward. Therefore, the vertical three-dimensional circulating garage provides a poor user experience. In addition, when a first vehicle needs to be stored in the garage when a second vehicle is being driven out, an enough space should be reserved to make sure that the second vehicle can be driven out normally, and thus the vertical three-dimensional circulating garage occupies more area of land and has a single form.

### SUMMARY

Embodiments of the present disclosure seek to solve at least one of the problems existing in the related art to at least some extent.

According to embodiments of the present disclosure, a three-dimensional circulating garage is provided. The three-dimensional circulating garage includes: a fixing frame including a first fixing support and a second fixing support spaced apart from and opposing to each other; a transmission system including a transmission device disposed on the fixing frame, and a tray track disposed on at least one of the first fixing support and the second fixing support; a plurality of tray units, and a driving device connected with the transmission device to drive the transmission device so as to drive the tray unit to move up and down reciprocally in a cyclical manner along the tray track. Each tray unit includes: a tray frame connected with the transmission device and having two rollers disposed on a top thereof, at least one roller of the tray frame being adapted to move in the tray track, a vehicle carrying plate connected to a lower end of the tray frame and configured to park a vehicle, and a tray stabilizing beam disposed on top of the tray frame. When two adjacent tray units move in a vertical direction, a lower surface of the vehicle carrying plate of an upper tray unit of the two adjacent tray units is supported on the tray stabilizing beam of a lower tray unit of the two adjacent tray units.

With the three-dimensional circulating garage according to embodiments of the present disclosure, by disposing two rollers on the top of the tray frame, when the tray unit moves, at least one roller fits with the tray track. Compared with a traditional three-dimensional circulating garage, a guiding wheel disposed at a lower end of the tray frame and a corresponding guiding wheel rail are cancelled. When the tray unit arrives at a lowermost position, the roller of the tray unit fits with a lowermost part of the tray track. Since no tray track is provided around the vehicle carrying plate, the vehicle can be driven into and out of the vehicle carrying plate straightly without being reversed, and thus a user experience is improved and it is convenient for a user to store or get the vehicle out, in addition, with the tray stabilizing beam, two adjacent tray units are supported by each other via the vehicle carrying plate and the tray stabilizing beam when moving in a vertical direction, and thus a stability of the tray unit can be improved when the tray unit moves in the vertical direction.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The disclosure is illustrated in the accompanying drawings, in which:

FIG. 1 is a schematic view of a three-dimensional circulating garage according to an embodiment of the present disclosure;

FIGS. 2-4 are schematic views of a plurality of tray units and a tray track fitted with the plurality of tray units from different perspectives according to an embodiment of the present disclosure;

FIG. 5 is a schematic view of a tray track according to an embodiment of the present disclosure;

FIG. 6 is a schematic view of a tray unit having two tray supporting plates according to an embodiment of the present disclosure;

FIG. 7 is a schematic view of a tray unit arriving at a lowermost position and fitted with a tray positioning device according to an embodiment of the present disclosure;

FIG. 8 is an enlarged view of part A in FIG. 7;

FIG. 9 is a schematic view of a tray positioning device according to an embodiment of the present disclosure;

FIG. 10 and FIG. 11 are schematic views of a driving device and a transmission system of a three-dimensional circulating garage from different perspectives according to an embodiment of the present disclosure;

FIG. 12 is a schematic view of a driving shaft having a second chain wheel and a third chain wheel of a three-dimensional circulating garage according to an embodiment of the present disclosure;

FIG. 13 is a schematic view of a first fixing support having a power supply device and a transmission system of a three-dimensional circulating garage according to an embodiment of the present disclosure;

FIG. 14 is an enlarged view of part B in FIG. 13;

FIG. 15 is an enlarged view of part C in FIG. 13;

FIG. 16 is a partially schematic view of a three-dimensional circulating garage according to an embodiment of the present disclosure;

FIG. 17 is a schematic view of a fixing frame according to an embodiment of the present disclosure;

FIG. 18 is a schematic view of a sliding wire guide rail and a current collector fitted with the sliding wire guide rail according to an embodiment of the present disclosure;

FIG. 19 is a cross-sectional view along direction D-D in FIG. 18;

FIG. 20 is an enlarged view of part E in FIG. 18;

FIG. 21 is a schematic view of a sliding wire guide rail and a current collector fitted with the sliding wire guide rail from another perspective according to the embodiment of the present disclosure in FIG. 18;

FIG. 22 is an enlarged view of part F in FIG. 21;

FIG. 23 is a schematic view of a sliding wire guide rail and a current collector fitted with the sliding wire guide rail from another perspective according to the embodiment of the present disclosure in FIG. 18;

FIG. 24 is an enlarged view of part G in FIG. 23;

FIG. 25 and FIG. 26 are schematic views of a sliding wire guide rail and a current collector fitted with each other and disposed on a first fixing support from different perspectives according to an embodiment of the present disclosure;

FIG. 27 is a schematic view of a tray unit having a charger and a conductive slip ring according to an embodiment of the present disclosure;

FIG. 28 is an enlarged view of part H in FIG. 27;

FIG. 29 is a schematic view of a conductive slip ring without a rotation stopping sheet according to an embodiment of the present disclosure; and

FIG. 30 and FIG. 31 are schematic views of a conductive slip ring having a rotation stopping sheet from different perspectives according to an embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, unless specified or limited otherwise, relative terms such as “center”, “longitudinal”, “lateral”, “width”, “thickness” “front”, “rear”, “right”, “left”, “lower”, “upper”, “vertical”, “above”, “below”, “up”, “top”, “bottom”, “clockwise”, “anticlockwise”, “axial direction”, “radial direction”, “circumferential direction”, as well as derivative thereof (e.g., “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the description of the present disclosure, unless specified or limited otherwise, it should be noted that, terms “mounted,” “connected” “coupled” and “fastened” may be understood broadly, such, as permanent connection or detachable connection, electronic connection or mechanical connection, direct connection or indirect connection via intermediary, inner communication or interaction between two elements. Those having ordinary skills in the art should understand the specific meanings in the present disclosure according to specific situations.

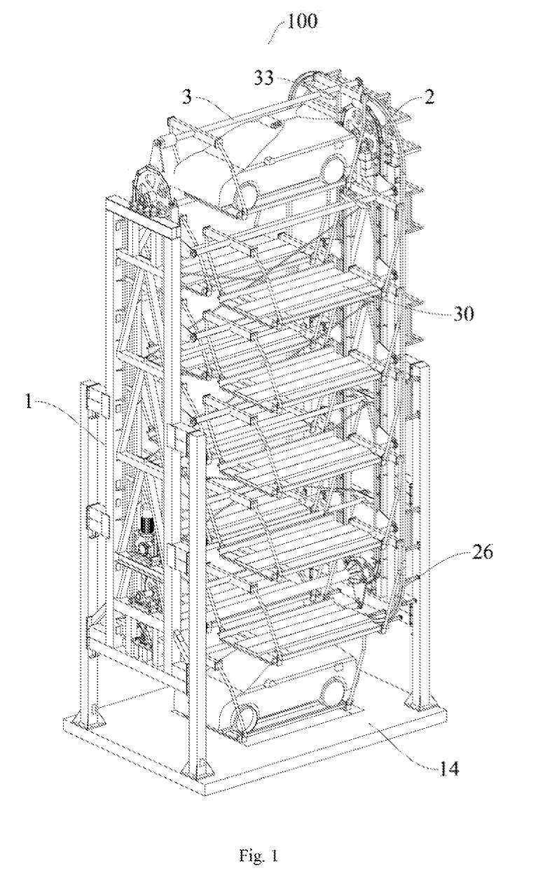

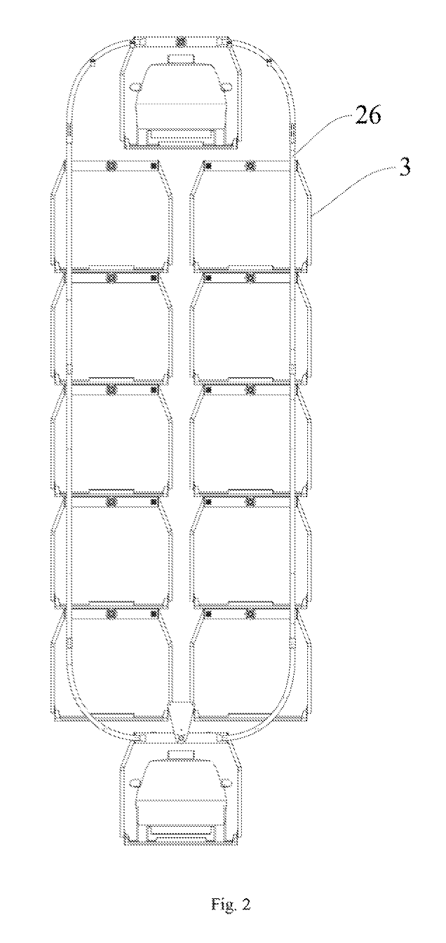

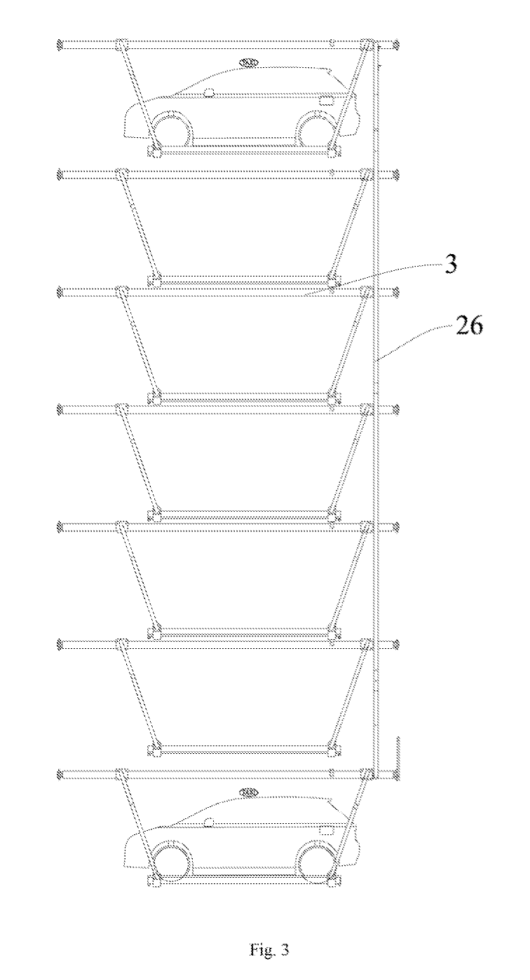

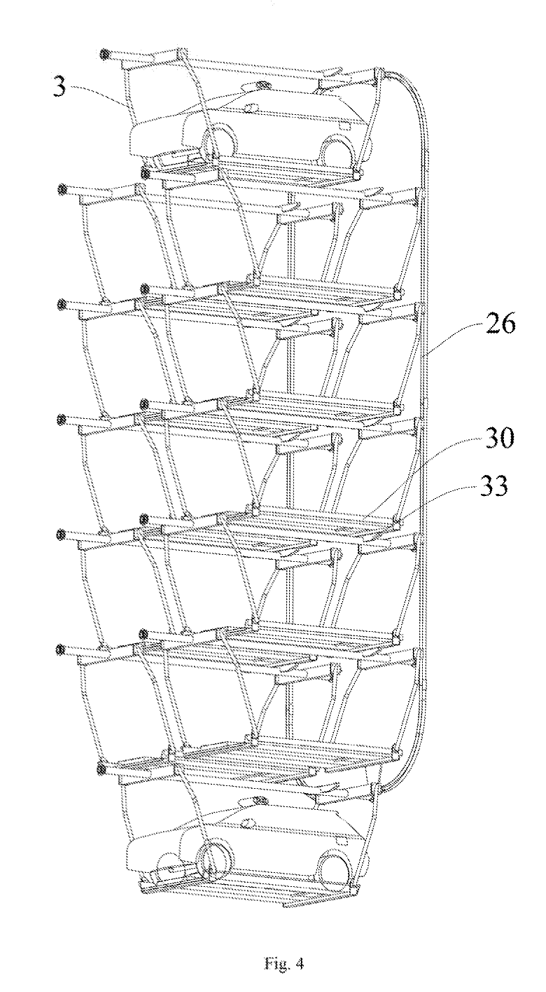

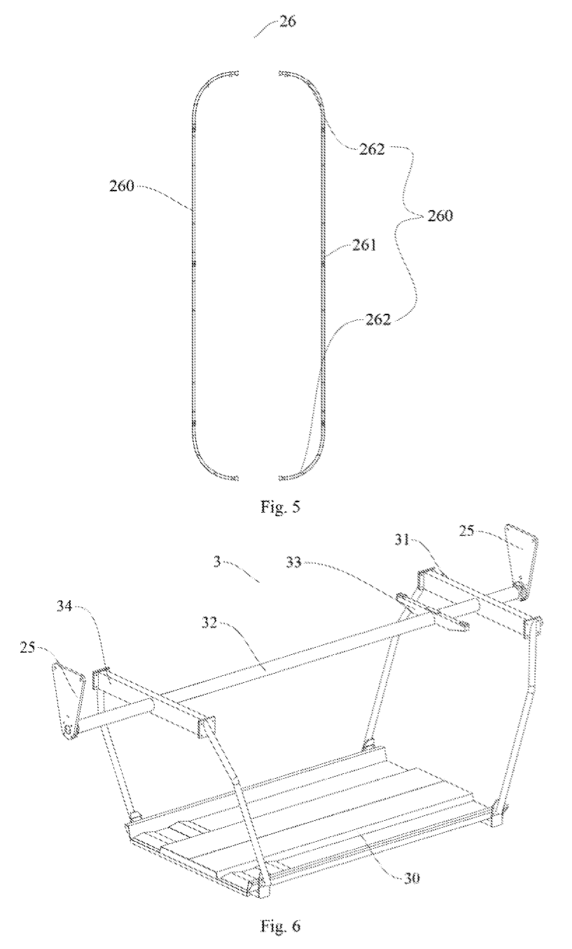

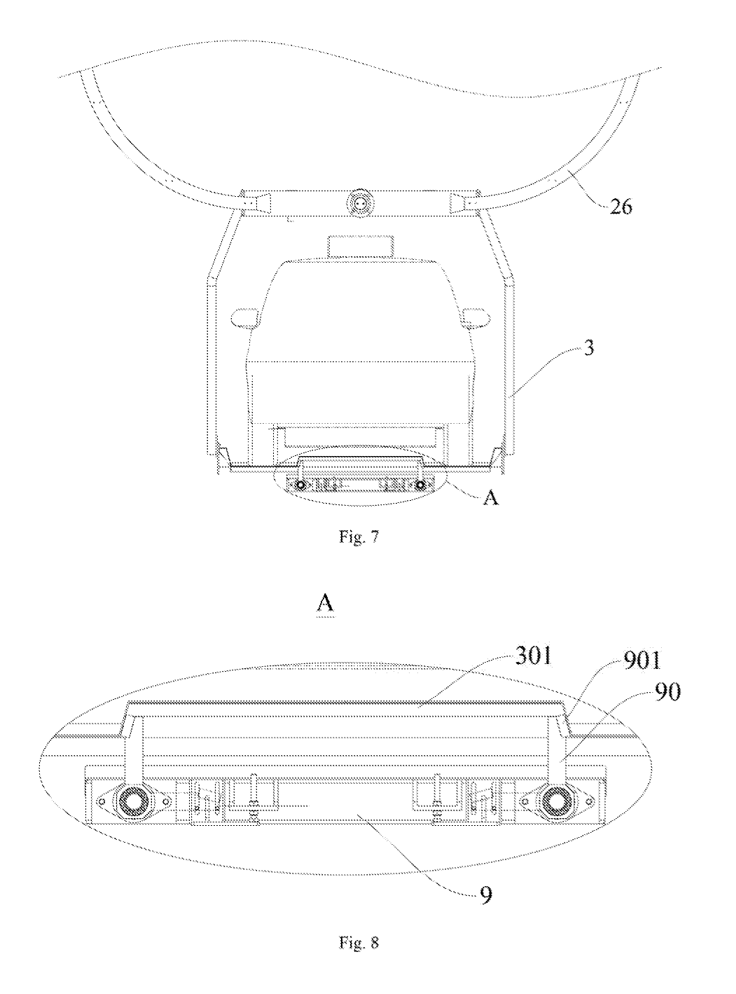

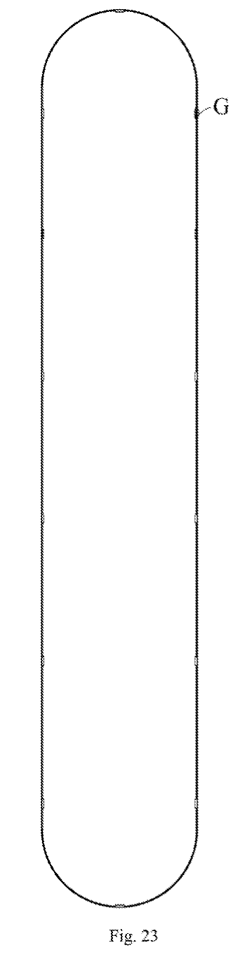

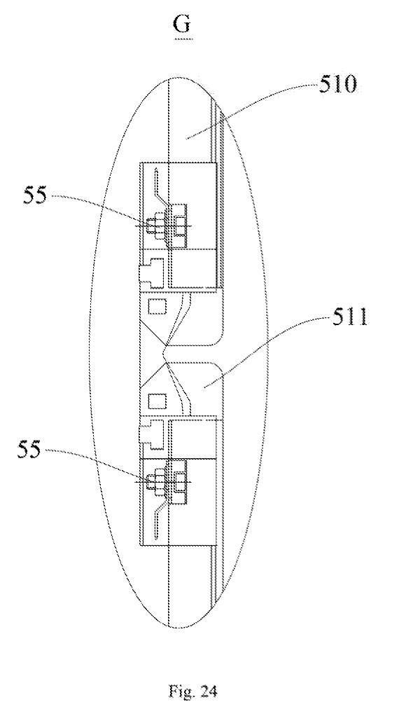

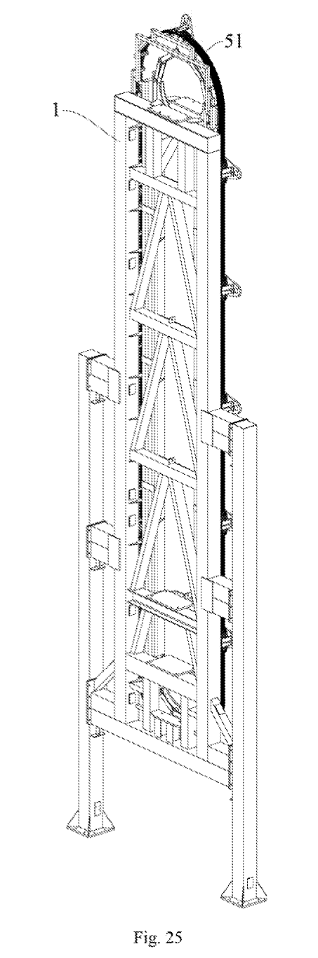

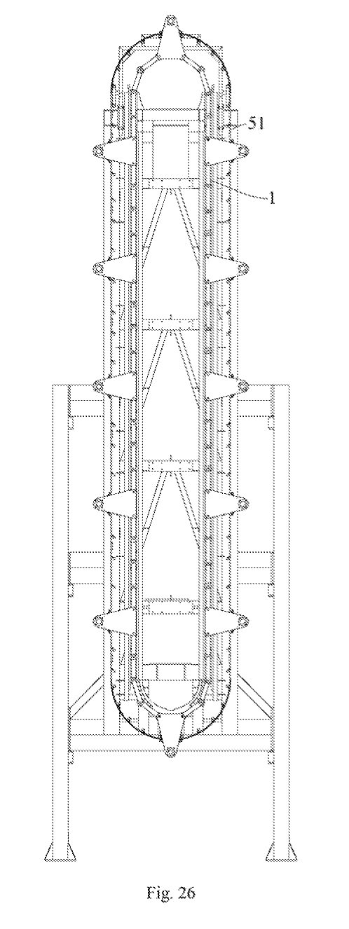

As shown in FIGS. 1-31, according to embodiments of the present disclosure, a three-dimensional circulating garage 100 is provided. The three-dimensional circulating garage 100 may be used for storing vehicles.

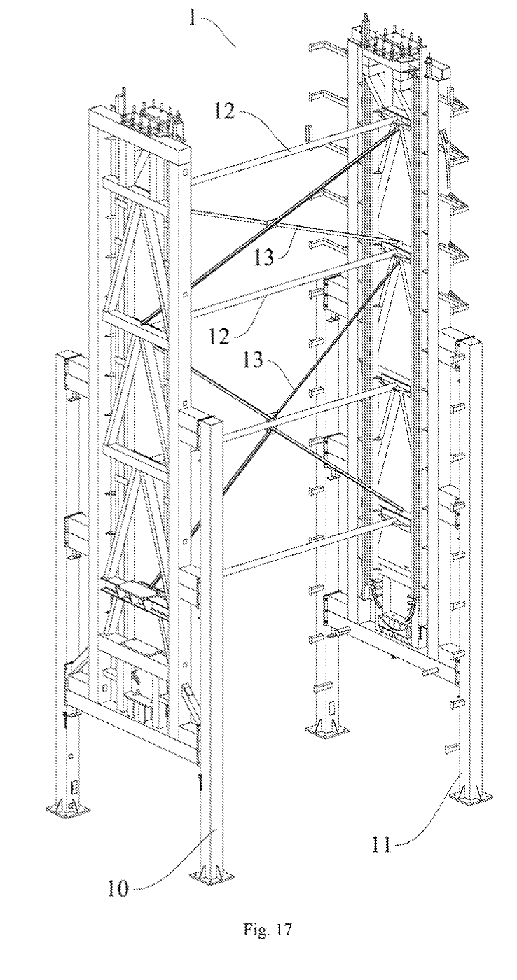

As shown in FIG. 1, the three-dimensional circulating garage 100 includes a fixing frame 1, a transmission system 2, a plurality of tray units 3 and a driving device 4. The fixing frame 1 includes a first fixing support 10 and a second fixing support 11 spaced apart from and opposed to each other. Specifically, in an embodiment as shown in FIG. 1 and FIG. 17, the first fixing support 10 and the second fixing support 11 are spaced apart from and parallel to each other in a right and left direction.

The transmission system 2 includes a transmission device and a tray track 26. The tray track 26 is disposed on at least one of the first fixing support 10 or the second fixing support 11, and the transmission device is disposed on the fixing frame 1. It should be noted that when the tray track 26 is disposed on the first fixing support 10, the tray tack 26 should be disposed on a side wall of the first fixing support 10 facing the second fixing support 11; when the tray track 26 is disposed on the second fixing support 11, the tray tack 26 should be disposed on a side wall of the second fixing support 11 facing the first fixing support 10.

The tray unit 3 includes a tray frame 34 and a vehicle carrying plate 30 configured to park vehicles. The vehicle carrying plate 30 is connected to a lower end of the tray frame 34. The tray frame 34 has two rollers 31 disposed on a top thereof and at least one of the two rollers 31 of the tray frame 34 is configured to move in the tray track 26. The tray frame 34 of the tray unit 3 is connected with the transmission device. A tray stabilizing beam 33 is disposed on a top of the tray frame 34 of the tray unit 3.

Specifically, the tray track 26 includes two sub-tracks 260 and each sub-track 250 includes a vertical segment 261 and two bending segments 262. The vertical segment 261 extends in a vertical direction, and two bending segments 262 of one sub-track 260 are bent and extended from as upper end and a lower end of the vertical segment 261 of the one sub-track 260 to the other sub-track 260 respectively, The bending segment 262 is configured as an arc segment. When the tray unit 3 slides on the vertical segment 261, one roller 31 of the tray unit 3 rolls on the vertical segment 261. When the tray unit 3 moves to an uppermost position or a lowermost position of the tray track 26, the two rollers 31 of the tray unit 3 are located on the two sub-tracks 260 respectively, such that the tray unit 3 can move from one sub-track 260 to the other sub-track 260, and thus the tray unit 3 can move up and down reciprocally in a cyclical manner along the tray track 26.

The driving device 4 is connected with the transmission device to drive the transmission device so as to drive the tray unit 3 to move up and down reciprocally in the cyclical manner along the tray track 26. When two adjacent tray units 3 move in a vertical direction, a lower surface of the vehicle carrying plate 30 of an upper tray unit 3 of the two adjacent tray units 3 is supported on the tray stabilizing beam 33 of a lower tray unit 3 of the two adjacent tray units 3. That is, when two tray units 3 move on the vertical segment 261, the tray stabilizing beam 33 of the lower tray unit 3 supports the lower surface of the vehicle carrying plate 30 of the upper tray unit 3 so as to support the upper tray unit 3.

It should be noted that the tray unit 3 moves up and down reciprocally in the cyclical manner along the tray track 26, which means a motion path of the tray unit 3 has an annular shape, and the tray unit 3 moves reciprocally along the motion path. It should be pointed out that the fit between the tray unit 3 and the transmission device should make sure that the vehicle carrying plate 30 is stable during a moving process of the tray unit 3. That is, a gravity center of the vehicle should always be kept downward in order to guarantee a safety of the vehicle placed on the vehicle carrying plate 30.

It should be noted that the transmission device may be configured as any common structure, as long as the transmission device can drive the tray unit 3 to move reciprocally up and down in the cyclical manner. Also, the driving device 4 may be configured as any common structure, as long as the driving device 4 can drive the transmission device to drive the tray unit 3 to move reciprocally up and down in the cyclical manner.

According to an embodiment of the present disclosure, the three-dimensional circulating garage 100 further includes a control device (not shown), and the control device is connected with the driving device 4 so as to control the driving device 4 to run or stop. In some embodiments, the control device includes a manual operation interface, and thus a user can control the driving device 4 via the manual operation interface (for example through swiping a card or pressing a button) to love the tray unit 3 to the lowermost position so as to take out the vehicle. Also the user can control the driving device 4 to run or stop via the manual operation interface.

With the three-dimensional circulating garage 100 according to the present disclosure, by disposing two rollers 31 on the top of the tray frame 34, when the ray unit 3 moves, at least one roller 31 fits with the tray track 26. Compared with a traditional three-dimensional circulating garage, a lower guiding wheel of the tray disposed one lower end of the tray frame and a corresponding guiding wheel rail are cancelled. When the tray unit 3 arrives at the lowermost position, the roller 31 of the tray unit 3 is fitted with the lowermost part of the tray track 26. Since no tray track 26 is provided around the vehicle carrying plate 30, the vehicle can be driven into or out of the vehicle carrying plate 30 straightly without being reversed, and thus a user experience is improved and it is convenient for a user to store or get the vehicle out. In addition, with the tray stabilizing beam 33, two adjacent tray units 3 may be supported by each other via the vehicle carrying plate 30 and the tray, stabilizing beam 33 when the two adjacent tray units 3 moves in the vertical direction, and thus stability of the tray unit 3 can be improved when the tray unit 3 moves in the vertical direction.

According, to some embodiments of the present disclosure, the three-dimensional circulating garage 100 further includes a tray positioning device 9 disposed on an upholder. In some embodiments, the upholder may be the ground, In another embodiment, the fixing frame further includes a base 14 configured to support the first fixing support 10 and the second fixing support 11, and the upholder includes the base 14.

The tray positioning device 9 includes a positioning arm 90 rotatable between a horizontal position and a vertical position. When the positioning arm 90 rotates to the vertical position, the positioning arm 90 contacts a lower surface of the vehicle carrying plate 30 of a lowermost tray unit 3 so as to play a role of positioning. That is, when the vehicle is needed to be placed on the vehicle carrying plate 30 or taken out from the vehicle carrying plate 30, first an empty tray unit 3 or a tray unit 3 with a vehicle is driven to the lowermost position of the tray track 26, and then the positioning arm 90 of the tray positioning device 9 rotates to the vertical position to contact the lower surface of the vehicle carrying plate 30 so as to position the tray unit 3, and therefore, the tray unit 3 is prevented from shaking due to a gravity center displacement generated by the vehicle running into or out of the tray unit 3.

When the tray unit 3 moves upward from the lowermost position of the tray track 26, the positioning arm 90 rotates to the horizontal position make sure that the tray unit 3 can pass normally. Therefore, with the tray positioning device 9, the security and stability can be ensured when the vehicle moves into or out of the garage. It should be noted that, when the positioning arm 90 rotates to the vertical position, the positioning arm 90 should be strong enough to bear relatively large impact force so as to ensure that the positioning arm 90 can position the vehicle carrying plate 30 in the vertical position.

According to some embodiments of the present disclosure, the tray positioning device 9 further includes a positioning bracket, two rotation shafts 92 and a driving assembly. The rotation shaft 92 is disposed on and penetrated through the positioning bracket, and the positioning arm 90 is disposed on each end of the rotation shaft 90 extended out the positioning bracket. The driving assembly is connected with the two rotation shafts 92 to drive the two rotation shafts 92 to rotate so as to rotate the positioning arm 90.

That is, the tray positioning device 9 includes four positioning arms 90. The four positioning arms 90 are divided into two groups, and each group of positioning arms 90 includes two positioning arms 90 which are driven to rotate by one rotation shaft 92. When the tray unit 3 is needed to be positioned and supported, the driving assembly drives the two rotation shafts 92 to rotate so as to rotate the four positioning arms 90 to the vertical position; and when it is needed to keep clear of the tray unit 3, the driving assembly drives the two rotation shafts 92 to rotate so as to rotate the four positioning arms 90 to the horizontal position. With the four positioning arms 90 and the two rotation shafts 92, the positioning stability of the tray positioning device 9 is improved, and a structure of the tray positioning device 9 is simple.

It should be noted that, the driving assembly may be configured as any commonly known structure, as long as the driving assembly can drive the rotation shaft 92 to rotate so as to drive the positioning arms 90 to rotate between the vertical position and the horizontal position.

In some embodiments of the present disclosure, as shown in FIGS. 6-8, a positioning groove 301 recessed upwards is formed in a lower surface of the vehicle carrying plate 30 of the tray unit 3. It should be noted that the positioning slot 301 may be formed by upwardly bending a part of the vehicle carrying plate 30, and the positioning slot 301 may have a rectangle shape. A damping block 901 is disposed on the positioning arm 90. When the positioning arm 90 rotates to the vertical position, the damping block 901 contacts a side wall of the positioning groove 301. In some embodiments of the present disclosure, the damping block 901 may be made of polyurethane. Thus, the positioning stability of the tray positioning device 9 can be further improved, and damages to the positioning arm 90 and the vehicle carrying plate 30 due to a collision occurred therebetween can be avoided.

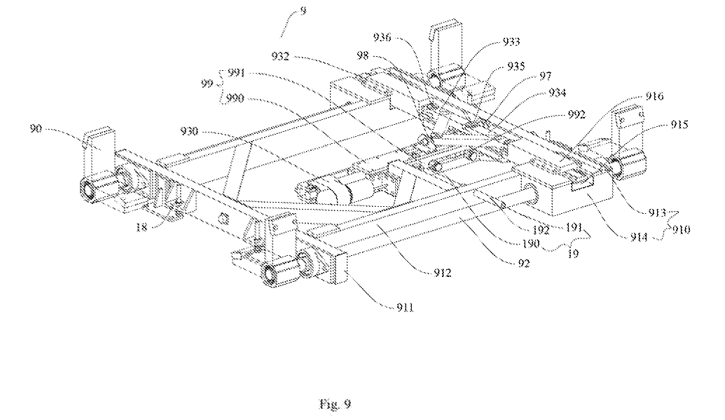

In some embodiments of the present disclosure, as shown in FIG. 9, the driving assembly includes a first driver 930, two ear and rack assemblies, a first connecting rod 933 and a second connecting rod 934. In one embodiment, the first driver 930 includes a linear actuator 930, and the linear actuator 930 includes a push rod connected with the first rotation shaft 935, and thus the first diver 930 has a simple structure.

It should be noted that a work principle of the linear actuator is common known by those skilled in the related art, and thus detailed description is omitted herein. It should be noted that the first driver 930 may be configured as any other structure, as long as the first driver 930 can drive the first rotation shaft 935 to move horizontally. For example, in one embodiment, the first driver 930 includes an air cylinder.

In one embodiment, the gear and rack assembly includes a gear (not shown) and a rack 932 engaged with the gear. The gear is fitted over the rotation shaft 92, and the rack 932 is horizontally movably disposed on the positioning bracket. A first end of the first connecting rod 933 is rotatably disposed on a first end of the second connecting rod 934 via the first rotation shaft 935, and a second end of the first, connecting rod 933 and a second end of the second connecting rod 934 are rotatably disposed on two racks 932 respectively. The first driver 930 is connected to the first rotation shaft 935 so as to drive the first rotation shaft 935 to move between a first position and a second position. When the first rotation shaft 935 moves to the first position, the positioning arm 90 rotates to tie vertical position, and when the first rotation shaft 935 moves to the second position, the positioning arm 90 rotates to the horizontal position.

That is, the rotation shaft 92 has a gear disposed thereon, and the gear is engaged with one rack 932. When the first driver 930 drives the first rotation shaft 935 to move horizontally, an included angle between the first connection rod 933 and the second connecting rod 934 varies, and at the same time, the first connecting, rod 933 and the second connecting rod 934 drive the rack 932 to move horizontally. Then, as the rack 932 is engaged with the gear, the rack 932 drives the gear to rotate, and also, as the gear is disposed on the rotation shaft 92, the gear drives the rotation shaft 92 to rotate. Thus, the positioning arm 90 is driven to rotate between the horizontal position and the vertical position. As a result, the driving assembly according to embodiments of the present disclosure has a simple and reliable structure.

In some embodiments of the present disclosure, as shown in FIG. 9, the tray positioning device 9 further includes a first sensor 97 and a second sensor 98. The first sensor 97 is configured to detect whether the first rotation shaft 935 is located in the first position, and the second sensor 98 is configured to detect whether the second rotation shaft 936 is located in the second position. The first sensor 97 and the second sensor 98 are connected with the first driver 930 respectively. The first driver 930 controls the first rotation shaft 935 to move according to detection results of the first sensor 97 and the second sensor 98. With the first sensor 97 and the second sensor 98, a position of the positioning arm 90 can be determined by detecting a position of the first rotation shaft 935, and thus an automatic degree of the tray positioning device 9 is improved.

In some embodiments, the first sensor 97 and the second sensor 98 may include a proximity sensor respectively. The first sensor 97 is disposed close to the first position, and the second sensor 98 is disposed close to the second position. It should be noted that a work principle of the proximity sensor is well known by those skilled in the related art, and therefore detailed descriptions thereof are omitted herein.

The tray positioning device 9 according embodiments of the present disclosure will be described hereafter by referring to FIGS. 7-9.

As shown in FIG. 9, according to an embodiment of the present disclosure, the tray positioning device 9 includes a positioning, bracket, a positioning arm 90, a rotation shaft 92 and a driving assembly. The positioning bracket includes a first bracket 910, a second bracket 911 and two connecting rods 912. The first bracket 910 and the second bracket 911 are arranged parallel to and spaced apart from each other. In one embodiment, the first bracket 910 and the second bracket 911 may be fixed on the upholder via an expansion bolt 18.

The two connecting rods 912 are spaced apart from each other, two ends of each connecting rod 912 are connected with the first bracket 910 and the second bracket 911 respectively, two ends of each rotation shaft 92 are extended out from the first bracket 910 and the second bracket 911, and the driving assembly is disposed between the first bracket 910 and the second bracket 911. Thus, the positioning bracket has a simple structure. In addition, as the tray positioning device 9 has a relative small volume, an occupied space of the tray positioning device 9 can be reduced.

In some embodiments, the first bracket 910 includes a bracket body 913 and two protection boxes 914. The bracket body 913 is parallel to the second bracket 911, the two protection boxes 914 are disposed on a side wall of the bracket body 913 facing the second bracket 911, and the two protection boxes 914 are spaced apart from each other and disposed on outsides of the two connecting rods 912 respectively. Furthermore, each protection box 914 is connected with one corresponding connecting rod 912.

A first end of the rotation shaft 92 passes through the protection box 914 and the bracket body 913 respectively, and a second end of the rotation shaft. 92 passes through the second bracket 911. A sliding groove 915 communicated with an interior of the protection box 914 is formed in an upper surface of the protection box 914.

In some embodiments, the driving assembly includes a linear actuator 930, two gear and rack assemblies, a first connecting rod 933 and, a second connecting rod 934. Each gear and rack assembly includes a gear and a rack 932. The gear is disposed in the protection box 914 and fitted over the rotation shaft 92. The rack 932 is movably disposed in the sliding groove 915 of the protection box 914. The rack 932 is engaged with a corresponding gear, and thus damage to people from the gear and rack assembly during an operation thereof can be avoided.

As shown in FIG. 9, in some embodiments, the positioning bracket further includes two protection covers 916. The two protection covers 916 are fixed on upper surfaces of two protection casings respectively and each protection cover 916 is disposed above the corresponding rack 932. Therefore, foreign matters can be prevented from entering the gear and rack assembly.

In some embodiments, a first end of the first connecting rod 933 is connected with a first end of the second connecting rod 934 via the first rotation shaft 935, and a second end of the first connecting rod 933 and a second end of the second connecting rod 934 are rotatably disposed on two racks 932 respectively via the second rotation shaft 936. In some embodiments, the linear actuator 930 includes a push rod connected with the first rotation shaft 935 so as to drive the first rotation shaft 935 to move horizontally.

In some embodiments, the tray positioning device 9 further includes a push plate assembly 99, the push plate assembly 99 includes a fixing base 991 and a push plate 990 horizontally movably disposed on an upper surface of the fixing base 991 and connected with the push rod, and the first rotation shaft 935 is connected with the push plate 990. With the push plate component 99, it is convenient to install the first rotation shaft 935. The first sensor 97 is disposed on the fixing base 991 and the second sensor 98 is disposed on a surface of the bracket body 913 facing the second bracket 911. In some embodiments, the first sensor 97 and the second sensor 98 include a proximity sensor respectively.

When it is needed to move the positioning arm 90 to the vertical position, first the linear actuator 930 is activated to drive the push plate 990 to move toward the first position, and then the first rotation shaft 935 is driven by the push plate 990 to move horizontally toward the first position. At the same time, the second end of the first connecting rod 933 and the second end of the second connecting rod 934 move far away from each other, so that two racks 932 are driven to move far away from each other. Movements of the two racks 932 drive two gears to rotate, so as to drive the rotation shafts 92 to rotate, and thus four positioning arms 90 rotate toward the vertical position. When the first rotation shaft 935 moves to the first position, the first sensor 97 detects that the first rotation shaft 935 is located in the first position, the first sensor 97 then sends a detected signal to the linear actuator 930. Then the linear actuator 930 stops running, the push plate 990 stops moving, and the four positioning arms 90 are positioned in the vertical position. As shown in FIG. 9, when the first rotation shaft 935 is in the first position, the first connecting rod 933 and the second connecting rod 934 are in a same line, i.e., an included angle between the first connecting rod 933 and the second connecting rod 934 is about 180 degrees.

When it is needed to move the positioning arm 90 to the horizontal position, first the linear actuator 930 is activated to drive the push plate 990 to move toward the second position, and then the first rotation shaft 935 is driven by the push plate 990 to move horizontally toward the second position. At the same time, the second end of the first connecting rod 933 and the second end of the second connecting rod 934 move toward each other, and thus two racks 932 are driven to move toward each other. Movements of the two racks 932 drive two gears to rotate, so as to drive the two rotation shafts 92 to rotate, and thus the four positioning arms 90 rotate toward the horizontal position. When the first rotation shaft 935 moves to the second position, the second sensor 98 detects that the first rotation shaft 935 is located in the second position, and the second sensor 98 then sends, a detected signal to the linear actuator 930. Then the linear actuator 930 stops running, the push plate 990 stops moving, and the four positioning arms 90 are positioned in the horizontal position. As shown in FIG. 9, when the first rotation shaft 935 is in the second position, there is an included angle formed between the first connecting rod 933 and the second connecting rod 934. Thus, the tray positioning device 9 according to embodiments of the present disclosure has a simple structure and a stable operation.

As shown in FIG. 9, in some embodiments, the three-dimensional circulating garage further includes a manual releasing device 19, and the manual releasing device 19 is connected with the first rotation shaft 935 so as to drive the first rotation 935 to move from the first position to the second position. By disposing the manual releasing device 19, when failures happen to the first driver 930, the first rotation shaft 935 can be moved from the first position to the second position by manual operations, and then the positioning arm 90 can rotate from the vertical position to the horizontal position. Thus, the positioning arm 90 located in the vertical position can be prevented from influencing normal operations of the tray unit 3, and the stability of the three-dimensional circulating garage can be improved. It should be noted that the manual releasing device 19 may be configured as any common structure, as long as the first rotation shaft 935 can be driven to move from the first position to the second position manually.

Specifically, as shown in FIG. 9, in some embodiments, the manual releasing device includes a moving rod 190 and a pull cord 191. The moving rod 190 is configured to be horizontally moveable, and a first end of, the moving rod 190 is connected with the first rotation shaft 935. And a first end of the pull cord 191 is wound on the moving rod 190, and a second end of the pull cord 191 is extended out of the positioning bracket. Thus, the moving rod 190 can be driven to move by pulling the pull cord 191, such that the first rotation shaft 935 can be driven to move from the first position to the second position. The manual releasing device has a simple structure. In some embodiments, the moving rod 190 may include a pin shaft disposed on and penetrated through a bottom of the first rotation shaft 935.

As shown in FIG. 9, in sonic embodiments, a moving track 992 is formed in the fixing base 991, a first end of the moving rod 190 passes through the moving track 992 and is extended into the fixing base 991 to connect to the push plate 990. That is, the first end of the moving rod 190 is fixed on the push plate 990. A second end of the moving rod 190 is outside of the fixing base 991, such that it is convenient to install the moving rod 190. In some embodiments, a protective cover 192 is fitted on, the connecting rod 912, a first end of the pull cord 191 is wound on the second end of the moving rod 190, and a second end of the pull cord 191 is extended out of the protective cover 192, and thus a damage to the connecting rod 912 caused by the movement of the pull cord 191 can be prevented, and the pull cord 191 can be prevented from being wound on the rotation shaft 92.

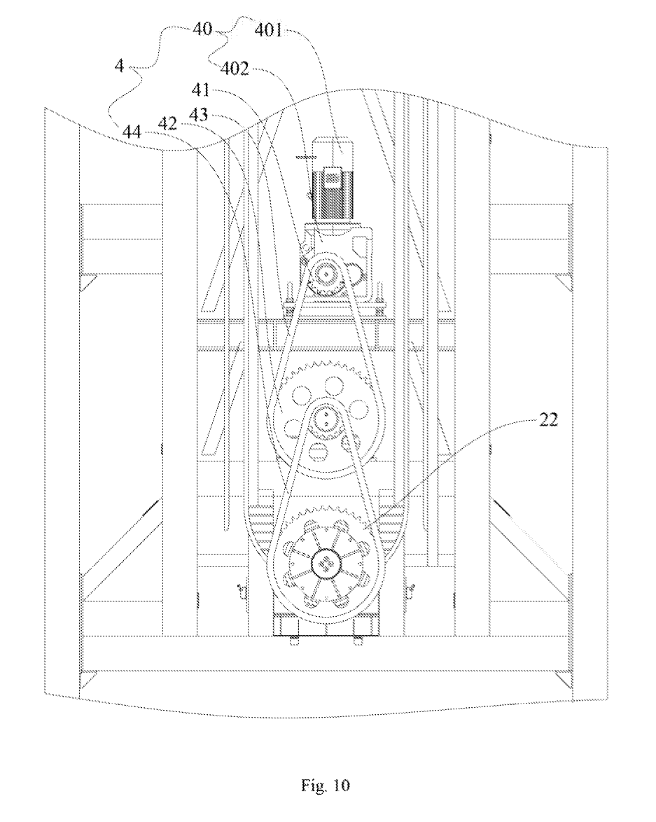

As shown in FIG. 10 and FIG. 11, in some embodiments, the driving device 4 includes a second driver 40 and a first chain wheel 141 driven by the second driver 40. That is, the second driver 40 is a power output element. In some embodiments, the second driver 40 may include an electrical machine 401 and a helical clear reducer 402 connected with an electrical machine shaft of the electrical machine 401. The first chain wheel 41 is fitted over an output shaft of the helical gear reducer 402. It should be noted that a work principle of the helical gear reducer 402 is well known by those skilled in the related art, and a detailed description thereof is omitted herein.

The transmission system 2 includes a driving shaft 20, two support wheels 23 and two first chains 24 having a ring shape. Two second chain wheels 21 are disposed on two ends of the driving shaft 20 respectively, and a third chain wheel 22 configured to be engaged with the first chain wheel 41 is disposed on one end of the driving shaft 20. The two ends of the driving shaft 20 with the third chain wheel 22 and two second chain wheel 21 are installed on the first fixing support 10 and the second fixing support 11 via a standard bearing seat 17. It should be noted that the term “standard” used herein refers drat the bearing seat 17 is a standard element. It should be noted that the third chain wheel 22 and the first chain wheel 41 may be fitted with each other by any common means, as long as the first chain wheel 41 can drive the third chain wheel 22 to rotate so as to rotate the driving shaft 20.

The two support wheels 23 are disposed on two side walls of the first fixing support and the second fixing support 11 facing each other respectively, and each support wheel 23 is configured as a chain wheel structure. The two first chains 24 are disposed on the first fixing support 10 and the second fixing support 11 respectively. Two sliding grooves (not shown) are formed in the two side walls of the first fixing support 10 and the second fixing support 11 facing each other respectively, and each first chain 24 is adapted to slide in a corresponding sliding groove. Each first chain 24 is fitted on the support wheel 23 and the second chain wheel 21 respectively, and thus the support wheel 23 plays a role of supporting the first chain 24, and the second chain wheel 21 plays, a role of driving the first chain 24 to rotate, and the support wheel 23 and the second chain wheel 21 are fitted with the corresponding first chain 24 via wheel-chain transmission. A plurality of tray supporting plates 25 are evenly disposed on each first chain 24, two ends of the tray frame 34 of each tray unit 3 are connected with corresponding tray supporting plates 25 disposed on the two first chains 24 respectively. In some embodiments, each tray frame 34 includes a tray shaft 32, and the tray shaft 32 of each tray unit 3 is rotatably connected with the corresponding tray supporting plates 25 of the two first chains 24.

Specifically, the second driver 40 operates to drive the first chain wheel 41 to rotate, then the first chain wheel 41 drives the third chain wheel 22 to rotate as the first chain wheel 41 is fitted with the third chain wheel, and the third chain wheel 22 drives the driving shaft 20 to rotate so as to drive the two second chain wheel 21 to rotate. As the two second chain wheel 21 are fitted with the two first chains 24 respectively, each first chain 24 are driven by the second chain wheel 21 to slide in the corresponding sliding groove, and thus the plurality of tray supporting plates 25 are driven to rotate, so as to move each tray unit 3 up and down reciprocally in a cyclical manner along the tray track. Thus, in embodiments of the present disclosure, the driving device 4 and the transmission system 3 have a simple structure. In some embodiments, as shown in FIG. 6, each tray supporting plate 25 is configured to have a triangular shape and provided with a bearing seat and a bearing.

It should be noted that the first chain 24 may be lengthened due to deformation during a use process thereof, and thus the two support wheels 23 should be moveably disposed on the first fixing support 10 and the second fixing support 11 respectively. When the first chain 24 is lengthened, a location of the support wheel 23 can be adjusted so as to ensure that the first chain 24 is supported on the support wheel 23 all the time.

In some embodiments of the present disclosure, as shown in FIG. 10 and FIG. 11, the driving device 4 further includes a duplex chain wheel 42, and the duplex chain wheel 42 is engaged with the first chain wheel 41 via a second chain 43, and engaged with the third chain wheel 22 via a third chain 44. That is, the second driver 40 operates to drive the first chain wheel 41 to rotate, the first chain wheel 41 drives the duplex chain wheel 42 to rotate via the second chain 43, and the duplex chain wheel 42 drives the third chain wheel 22 to rotate via the third chain 44. Thus, a double reduction can be obtained so as to reduce an occupied volume of the helical gear reducer 402.

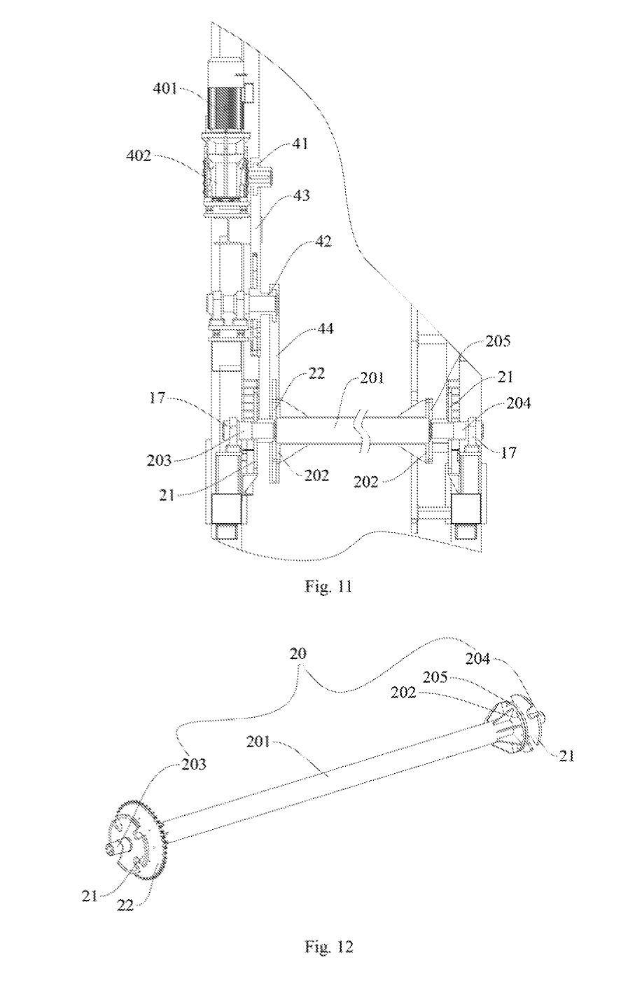

As shown in FIG. 11 and FIG. 12 in some embodiments of the present disclosure, the driving shaft 20 includes a shaft body 201, a first flange plate 202, a first shaft 203, a second shaft 204 and a second flange plate 205. The first flange plate 202 is disposed on each of two ends of the shaft body 201. The third chain wheel 22 and one second chain wheel 21 are sleeved on the first shaft 203, and the third chain wheel 22 is fixed on the corresponding first flange plate 202. The other second chain wheel 21 is sleeved on the second shaft 204, and the second flange plate 205 is disposed on an end of the second shaft 204 and fixed on the corresponding first flange plate 202. Specifically, the third chain wheel 22 is connected with the first flange plate 202 via a hinged bolt, and also, the second flange plate 205 is connected with the first flange plate 202 via a hinged bolt. Thus, compared with a traditional integrally welded structure, the driving shaft 20 utilizing a fixedly connected divided structure has low processing difficulty, high accuracy, an easy installation and a low maintenance cost.

In some embodiments, the three-dimensional circulating garage 100 further includes a power supply device 5. The power supply device 5 is connected with each tray unit 3 so as to charge a vehicle placed on the vehicle carrying plate 30. That is, the vehicle placed on the vehicle carrying plate 30 can be charged by the power supply device 5. It should be noted that not only the power supply device 5 can charge the vehicle placed on the vehicle carrying plate 30, but also the power supply device 5 should guarantee electrical safety to avoid personal injury, such as electric shock, to a user when the vehicle placed on the vehicle carrying plate 30 is cut off from the power supply device 5. It should be noted that the power supply device may be configured as any common structure, as long as it can charge the vehicle placed on the vehicle carrying plate 30.

Also, it should be understand that the power supply device should include a charging gun (not shown), and the vehicle includes a charging port matched with the charging gun. Each tray unit 3 should include one charging gun thereon, and the charging gun is adapted to be inserted into the charging port, such that the power supply device can charge the vehicle.

When it is needed to park a vehicle into the three-dimensional circulating garage, firstly, the vehicle runs onto the lowermost vehicle carrying plate 30 of the plurality of vehicle carrying plates 30, in which when the vehicle is an electric vehicle and needs to be charged, the user can connect the electric vehicle with the power supply device. Then the tray unit 3 with the vehicle in a charging state moves upward, and also, an empty vehicle carrying plate 30 moves to the lowermost position so as to prepare for a subsequent vehicle.

When it is needed to take the well, charged vehicle out of the three-dimensional circulating garage, by controlling the driving device 4 to operate, the vehicle carrying plate 30 on which the vehicle is placed is driven to move to the lowermost position, and then the user cuts off the vehicle front the power supply device and drives, the vehicle out of the three-dimensional circulating garage from the vehicle carrying plate 30.

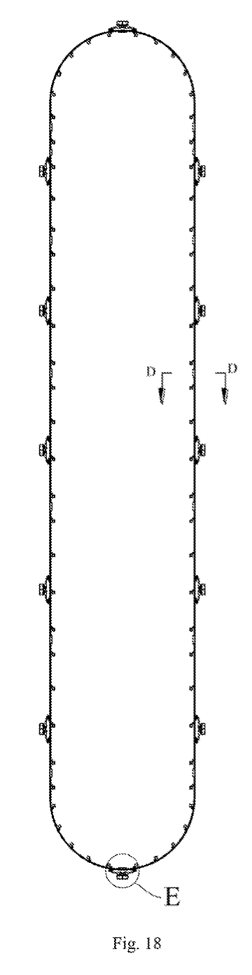

In some embodiments, as shown in FIGS. 18 to 31, the power supply device includes a plurality of chargers 50, a sliding wire guide rail 51 having a ring shape and a plurality of current collectors 52. The plurality of chargers 50 are correspondingly disposed on the plurality of tray frames 34 one to one so as to charge the vehicle placed on the vehicle carrying plate 30. Specifically, the plurality of chargers 50 are in correspondence with a plurality of charging guns, each charger 50 may work independently and has an active state and an inactive state. When the vehicle needs to be charged, the charger 50 is in the active state, and when the vehicle doesn't need to be charged, the charger 50 is in the inactive state. It should be noted that a work principle of the charger 50 may be transforming electricity obtained from the current collector 52 into certain voltage and electric current suitable for charging the electric vehicle. In some embodiments, the charger 50 has a function of calculating charging time, an electric quantity and a cost. The charger 50 may be configured as any common charger that known by those skilled in the related art, a structure of the charger 58 is well known by those skilled in the related art, and therefore detailed description thereof is omitted herein.

In some embodiments, the sliding wire guide rail 51 is disposed a side wall of the first fixing support 10 facing the second fixing support 11 and configured to connect with an external power supply. In some embodiments, the sliding wire guide rail 51 has an obround shape. The plurality of current collectors 52 are electrically connected with the sliding wire guide rail 51 and moveable on the sliding wire guide rail 51, and each current collector 52 is electrically connected with one charger 50 so as to transport electricity collected from the sliding wire guide rail 51 to the charger 50. It should be noted that the current collector 52 may be disposed on the transmission device or on the tray unit 3 such that the collector 52 can move in the sliding wire guide rail 51 along with the tray unit 3. In some embodiments, the current collector 52 is disposed on the tray supporting plate 25 so as to move along with the tray supporting plate 25.

Specifically, each of the sliding wire guide rail 51 and the current collector 52 is configured as a sliding wire. A plurality of copper wires (not shown) are disposed within the sliding wire guide rail 51, an electricity extracting head 520 of each current collector 52 has an electric point (not shown) in correspondence with each of the plurality of the copper wires. That is, each current collector 52 has one electric point for each copper wire, and each current collector 52 can slide on or in the sliding wire guide rail 51 and extract electricity from the copper wires in the sliding wire guide rail 51 by contacting the copper wires. It should be noted that a shape of the sliding wire guide rail 51 is consistent with a motion path of each tray unit 3 to assure that the tray unit 3 can move up and down reciprocally in a cyclical manner and the vehicle placed on each vehicle carrying, plate 30 can be charged. Thus, the power supply device 5 has a simple structure.

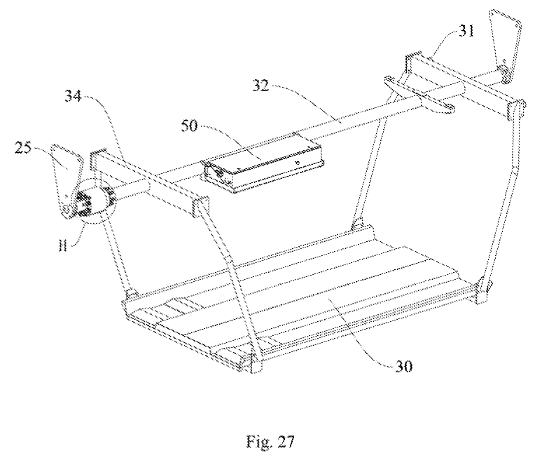

In some embodiments, as shown in FIG. 27, the power supply device 5 further includes a plurality of conductive slip rings 53. Each conductive slip ring 53 includes a stator 530 and a rotor 531 rotatable with respect to each other, and is connected with one charger 50 and the current collector 52 corresponding to the charger 50 respectively Thus, an electric current can be prevented from being interrupted when the stator 530 and the rotor 531 are relatively rotating. With the conductive slip ring 53 disposed. between the charger 50 and the current collector 52, a system fault caused by winding of connection wires of the current collector 52 and the charger 50 can be avoided, and thus the stability of the three-dimensional circulating garage 100 can be assured. It should be noted that a fitting relationship between the stator 530 and the rotor 531 is well known by those skilled in the related art, and therefore the detailed description is omitted herein.

In some embodiments, as shown in FIGS. 27 to 31, each tray frame 34 includes the tray shaft 32, and the transmission device includes the plurality of tray supporting plates 25. One tray supporting plate 25 is fitted over each end of the tray shaft 32, and the tray shaft 32 is rotatable relative to the tray supporting plate 25. Thus, the vehicle carrying plate 30 can swing along an axial direction and a circular direction, that is, the gravity center of the vehicle carrying plate 30 can maintain downward due to its own weight and the vehicle's weight when the tray unit 3 moves up and down reciprocally in the cyclical manner. Specifically, two ends of the tray shaft 32 are installed on the bearing seats of the corresponding tray supporting plates 25 respectively.

In some embodiments, the stator 530 is sleeved on the tray shaft 32 and connected to the tray supporting plate 25, and the stator 530 is still relative to the tray supporting plate 25. The rotor 531 is sleeved on the tray shaft 32 and still relative to the tray shaft 32. Specifically, the rotor 531 may be fixed on the tray shaft 32 via a jackscrew 536, and thus the rotor 531 is still relative to the tray shaft 32.

In some embodiments, an lead-in terminal 534 configured to connect with the power supply is disposed on n end surface of the stator 530 facing the tray supporting plate 25, and an lead-out terminal 535 configured to connect with the charger 50 is disposed on an end surface of the rotor 531 away from the stator 530. A first outside cable connected with the power supply is connected to the lead-in terminal 534 such that the conductive slip ring 53 can be electrically connected to the power supply, and a second outside cable connected with the charger 50 is connected to the lead-out terminal 535 such that the conductive slip ring 53 cab be electrically connected to the charger 50. That is, since the stator 530 is still relative to the tray supporting plate 25 and the rotor 531 is still relative to the tray shaft 32, when the tray shaft 32 rotates relative to the tray supporting plate 25, the rotor 531 rotates relative to the stator 530.

With the three-dimensional circulating garage 100 according to embodiments of the present disclosure, the stator 530 and the rotor 531 are fitted over the tray shaft 32, the stator 530 is still relative to the tray supporting plate 25 and the rotor 531 is still relative to the rotation shaft 92, so that the installation of the conductive slip ring 53 cannot influence the installation of other pans, and a space occupation of the conductive slip ring 53 in a length direction of the tray shaft 32 is not limited, and thus it is suitable for conditions in which a large current is required. Also, since each of the stator 530 and the rotor 531 has a hollow structure, and the lead-in terminal 534 and the lead-out terminal 535 are disposed on two ends of the conductive slip ring 53, there is no need to route an electric cable inside the tray shaft when installing the electric cable. Thus, the manufacturing difficulty of the tray unit 3 is simplified, and the manufacturing cost is reduced.

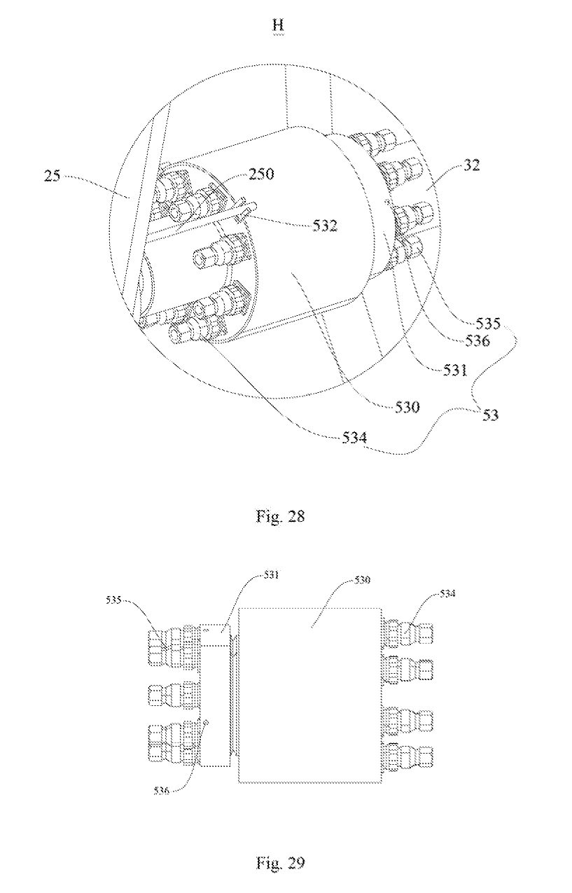

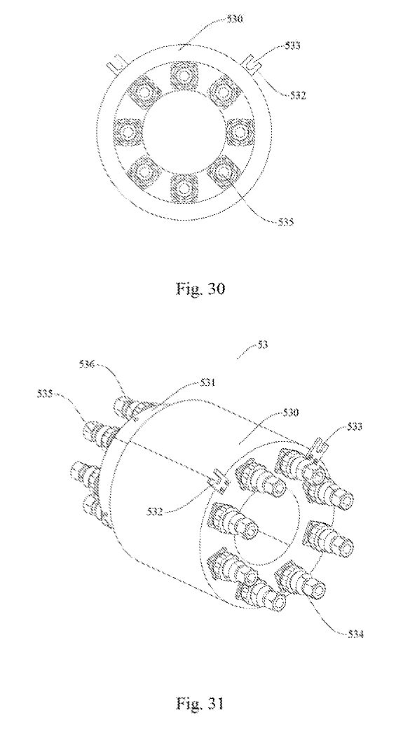

In some embodiments, as shown in FIG. 28, each stator 530 includes a rotation stopping sheet 532, and each tray supporting plate 25 includes a rotation stopping fork 250. The rotation stopping fork 250 is connected with the rotation stopping sheet 532 such that each stator 530 is still relative to the corresponding tray supporting plate 25. That is, the stator 530 is connected with the tray supporting plate 25 via the rotation stopping sheet 532 and the rotation stopping fork 250, and thus an assembling relationship between the stator 530 and the tray supporting plate 25 is simple. In some embodiments, there is a plurality of the rotation stopping sheets 532, and also, there is a plurality of the rotation stopping fork 250 correspondingly. The plurality of rotation stopping sheets 532 is corresponding to the plurality of rotation stopping forks 250 one to one, and thus the connection stability between the stator 530 and the tray supporting plate 25 can be improved, and it guaranteed that the stator 530 is still relative to the tray supporting plate 25. As shown in FIG. 30 and FIG. 31, there are two rotation stopping sheets 532.

In further embodiments, as shown in FIG. 27, FIG. 28, FIG. 30 and FIG. 31, in order to facilitate the rotation stopping fork 250 connecting with the rotation stopping sheet 532, an installation groove 533 is formed in the rotation stopping sheet 532 and a free end of the rotation stopping fork 250 is fitted with the installation groove 533. In some embodiments, the rotation stopping sheet 532 has, a rectangle shape, and an inlet of the installation groove 533 is in an end surface of the stator 530 in a radial direction.

In some embodiments, the rotation stopping fork 250 includes a cylindrical rod, and thus the rotation stopping fork 250 has a simple structure and a low manufacturing cost. In some embodiments, as shown in FIG. 28, FIG. 30 and FIG. 31, the rotation stopping sheet 532 is disposed on an end surface of the stator 530 facing the tray supporting plate 25. Specifically, the rotation stopping sheet 532 may be fixed on the stator 530 via a fixing member. For example, the fixing member is a screw.

In some embodiments, each of the lead-in terminal 534 and the lead-out terminal 535 includes an aviation plug, and thus it is convenient for installation and maintenance, and the conductive slip ring 53 can be protected from being scraped due to cable damage so as to reduce the usage cost.

In some embodiments, as shown in FIGS. 18-26, the sliding wire guide rail 51 includes a plurality of sub-sliding wires 510 and a plurality of insulation segmentation components 511, and each two adjacent sub-sliding wires 510 are spaced apart from each other and connected with each other via one insulation segmentation element 511. The electricity extracting a head 520 of each current collector is slidable on the sub-sliding wire 510 and the insulation segmentation element 511. When sliding on the sub-sliding wire 510, the electricity extracting head 520 can obtain electricity from the sub-sliding wire 510. Each sub-sliding wire 510 is adapted to connect with the external power supply, and each charger 50 is connected with two current collectors 52. When each tray unit 3 is operating, e.g. moving, at least one of the two current collectors 52 corresponding to the charger 50 is electrically connected the sub-sliding wire 510. Thus, the charger 50 can always receive the electricity obtained from the sub-sliding wire 510 by the current collector 52, and a condition in which the electricity to the vehicle is cut off while the vehicle is being charged can be avoided. In addition, the three-dimensional circulating garage 100 can charge several vehicles placed on the vehicle carrying plates 30 at the same time, and the sliding wire guide rail 51 and the current collector 52 can be prevented from being destroyed due to a large power or an over current.

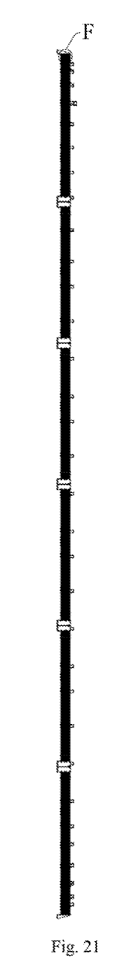

In some embodiments, as shown in FIG. 20, the two current collectors 52 corresponding to each charger 50 are connected with each other via an installation, frame 54, and the installation frame 54 is disposed on the tray supporting plate 25 such that each current collector 52 cart slide on the sliding wire guide rail 51 along with the movement of the tray unit 3.

In other words, each two adjacent sub-sliding wire 510 are separated from each other by one insulation segmentation element 511, and the plurality of sub-sliding wires 510 and the plurality of insulation segmentation elements 511 are connected with one another to form the sliding wire guide rail 51 which has the ring shape. The external power supply supplies power to each sub-sliding wire 510, i.e., the sliding wire guide rail 51 is supplied with power through multiple points, namely in a multi-point power supply manner. Thus, due to the multi-point power supply, an electric current passing through each sub-sliding wire 510 is reduced, and each sub-sliding wire 510 cannot influence one another, so that the whole system can run normally and safely, and it is convenient for maintenance and troubleshooting of the whole system.

In some embodiments, each sub-sliding wire 510 has two electric contacts located at two ends of each sub-sliding wire 510 respectively. Specifically, in one embodiment, the insulation segmentation element 511 includes two cable connectors 55 which are configured as the electric. contacts of the corresponding sub-sliding wire 510. It should be noted that a part of the insulation segmentation element 511 located between the two sub-sliding wires 510 connected therewith should be made of insulating material, such that the two adjacent sub-sliding wires 510 are insulated and spaced apart from each other by the insulation segmentation element 511. And, a part of the insulation segmentation element 511 used for installing the cable connector 55 may be made of conductive material such that electric cu rent can be easily transmitted into the sub-sliding wire 510.

In some embodiments, each sub-sliding wire 510 has an equal length, and a number of the sub-sliding wires 510 is equal to that of the vehicle carrying plates 30. For example, in one embodiment, the three-dimensional circulating garage includes twelve vehicle carrying plates and twelve sub-sliding wires 510, and thus the electric current passing through the sliding wire guide rail 51 is reduced, and the three-dimensional circulating garage 100 can operate normally and safely. It should be noted that, when the sub-sliding wire 510 is configured to have an arc shape, the length of the sub-sliding, wire 510 refers to an arc length of the sub-sliding wire 510.

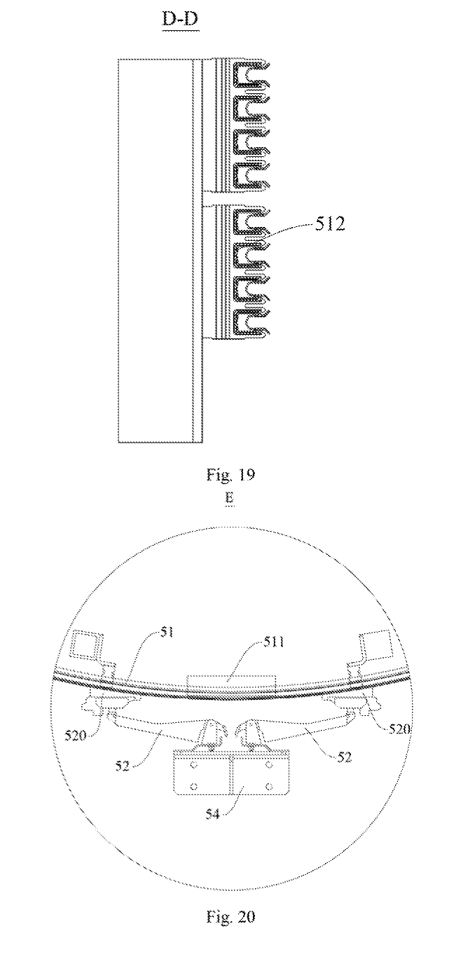

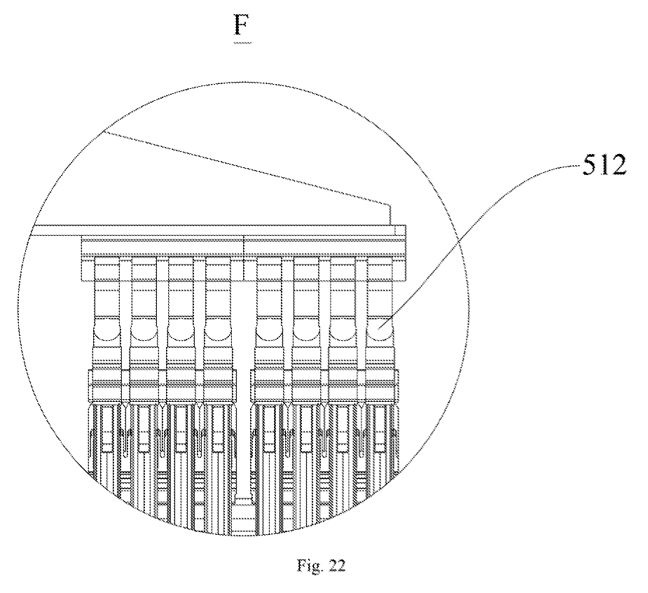

In some embodiments, as shown in FIG. 19 and FIG. 22 each sub-sliding wire 510 includes a plurality of single-stage sliding contact wires 512, in which two single-stage sliding contact wires 512 single-stage sliding contact wire are connected with a ground wire and a null line respectively, and other single-stage sliding contact wires 512 are connected with a live wire respectively. A row number of the single-stage sliding contact wires 512 may be determined according to actual needs. It should be noted that, when each sub-sliding wire 510 includes a plurality of single-stage sliding contact wires 512, each cu rent collector 52 includes a plurality of electricity extracting heads 520. The plurality of electricity extracting heads 520 slide on the plurality of single-stage sliding contact wires 512 respectively so as to collect electricity from the single-stage sliding contact wires 512. It should be noted that, when the electricity extracting head 520 slides, an electricity collection principle between the eclectic head 520 and the single-stage sliding contact wire 512 is well known by those skilled in the related art, for example, it may be the same as an electricity collection principle between the sliding, wire guide rail and the current collector of a traditional sliding wire, or conductor bar, and therefore a detailed description thereof is omitted herein.

With the sliding wire guide rail 51 according to embodiments of the present disclosure, each sub-sliding wire 510 includes the plurality of single-stage sliding contact wire 512, and then an electric current in each single-stage sliding contact wire 512 is decreased, and a number of the single-stage sliding contact wires 512 connected to the live wire can be regulated according to a needed electric quantity. Therefore, stability of the power supply device can be improved and an early cost can be reduced. In addition, it is convenient for later maintenance and troubleshooting of the power supply device.

In one embodiment, two single-stage sliding contact wires 512 connected with each other in parallel are connected to a same live wire, and thus the electric current in each single-stage sliding contact wire 512 can be further decreased. For example, in one embodiment, each sub-sliding wire 510 includes eight single-stage sliding contact wires 512, six of the eight single-stage sliding contact wires 512 are divided into three groups, and each group includes two single-stage sliding contact wires 512 connected with each other in parallel. Each group is connected to a live wire of a three phase power source, and the other two of the eight single-stage sliding contact wires 512 are connected to a null wire and a ground wire of the three phase power source respectively.

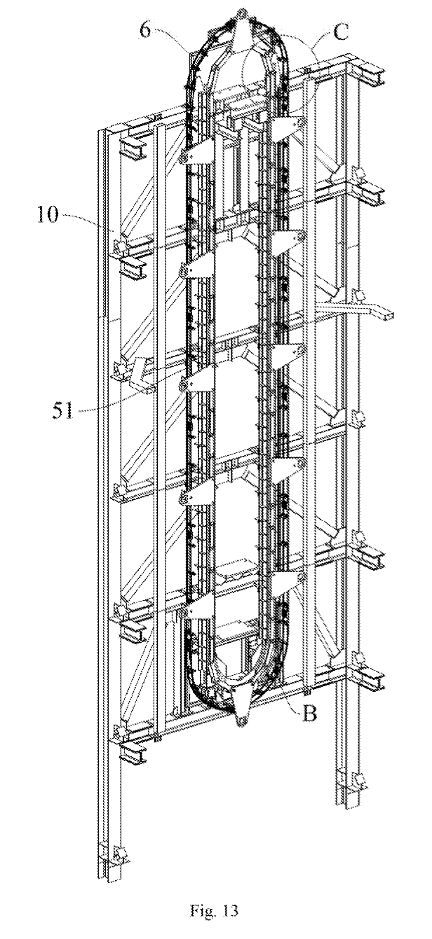

In some embodiments, as shown in FIG. 13, the three-dimensional circulating garage 100 further includes an expansion and contraction device 6 disposed on the first fixing support 10 and moveable in an up and down direction, the expansion and contraction device 6 is connected with the sliding wire guide rail 51 so as to drive the sliding wire guide rail 51 to stretch out and draw back when the expansion and contraction device 6 is moving along the up and down direction. Thus, it is convenient to install the three-dimensional circulating garage 100 and regulate the sliding wire guide rail 51 during the using process thereof.

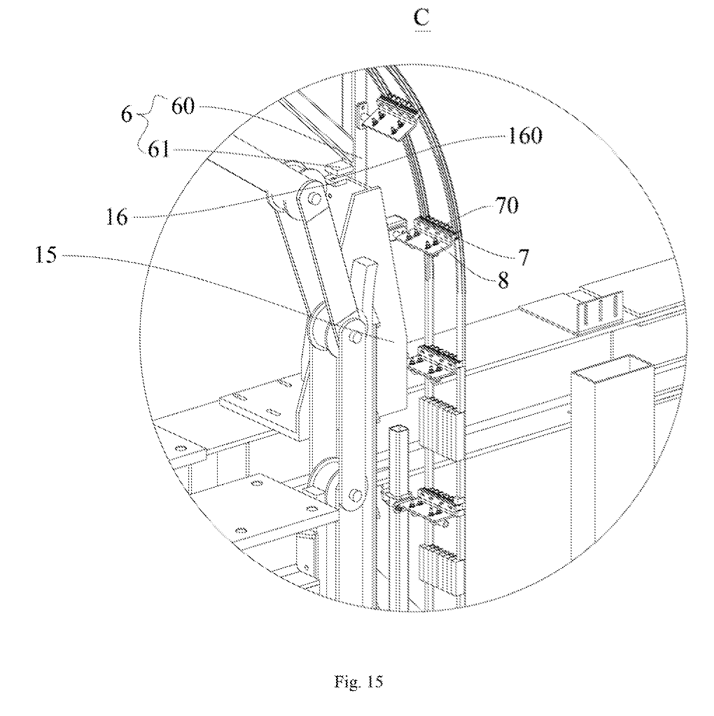

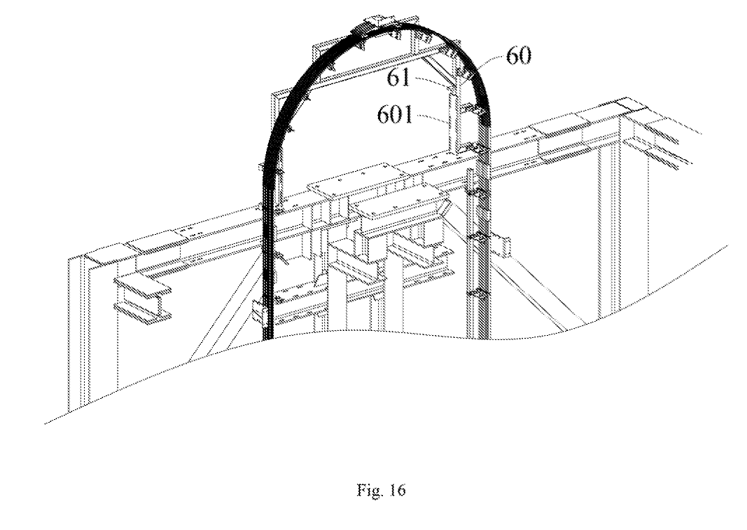

In some embodiments, as shown in FIG. 13, FIG. 15 and FIG. 16, a support frame 15 is fixed on an upper wall of the first fixing support 10, and a first regulating plate 16 is disposed on a top end of the support frame 15 and has a threaded hole 160 penetrated the first regulating plate 16 in a thickness direction thereof. In one embodiment, as shown in FIG. 13, there are two support frames 15, and the first regulating plate 16 is disposed on the top end of each support frame 15.

Specifically, a bottom end of the support frame 15 may be fixed on the top wall of the first fixing support 10 via welding or screw connection. It should be noted that there are no particular limitations for a shape of the support frame 15. For example, in one embodiment, the support frame 15 has a substantial L shape.

In some embodiments, the expansion and contraction device 6 includes an expansion and contraction frame 60, a second regulating plate 61 and a regulation fixing element (not shown). The expansion and contraction frame 60 is connected with the sliding wire guide rail 51, a regulating hole 601 having ate obround shape is formed in a lower portion of the expansion and contraction frame 60, the second regulating plate 61 over the first regulating plate 16 is disposed on the expansion and contraction frame 60, and the regulation fixing element passes through the regulating hole 601 and is fixed on the support frame 15. It should be noted that when there are two support frames 15, there are two second regulating plates 61 correspondingly. The two second regulating plates 61 are disposed on the expansion and contraction frame 60 respectively. The expansion and contraction frame 60 may be configured to be a frame whose bottom is open.

In some embodiments, the three-dimensional circulating garage 100 further includes a regulating element (not shown) fitted with the threaded hole 160, and an upper end of the regulating element passes through the threaded hole 160 and rests against a lower surface of the second regulating plate 61, such that a distance between the first regulating plate 16 and the second regulating plate 61 can be regulated by regulating a length of a portion of the regulating element stretched out of the threaded hole 160. It should be noted that the length of the portion of the regulating element stretched out of the threaded hole 160 is a length of a portion of the regulating element stretched out beyond the first regulating plate 16.

When an expansion amount of the sliding wire guide rail 51 needs to be regulated, the regulation fixing element s firstly loosen, so that the expansion and contraction frame 60 can move up and down relative to the support frame 15, and then the regulating element is turned to regulate the length of the portion of the regulating element stretched out of the threaded hole 160. As the upper end of the regulating element rests against the lower surface of the second regulating plate 61, the second regulating plate 61 is driven to move up and down by a movement of the regulating element, and thus the expansion and contraction frame 60 is driven to move up and down so as to drive the sliding wire guide rail 51 to stretch out and draw back. Thus, the sliding wire guide rail 51 can be regulated.

When the expansion and contraction frame 60 moves to a required position, the regulation fixing element is tighten, and thus the expansion and contraction frame 60 is fixed on the support frame 15 via the regulation fixing element.

With the expansion and contraction device 6 according to embodiments of the present disclosure, by providing the first regulating plate 16, the second regulating plate 61 and the regulating element, it is convenient to regulate an up and down movement of the expansion and contraction frame 60, thus facilitating the regulation of the sliding wire guide rail 51.

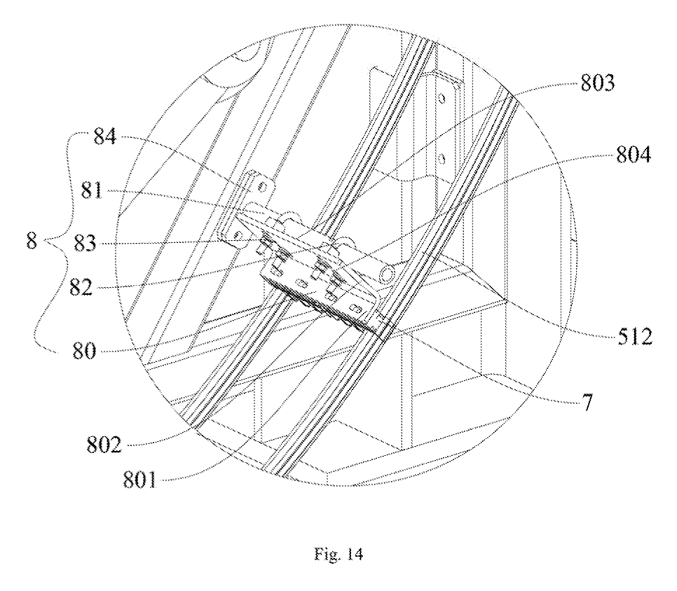

In some embodiments, as shown in FIG. 13 and FIG. 14, the three-dimensional circulating garage 100 further includes a plurality of clamps 7 sleeved on the sliding wire guide rail 51, and a plurality of regulating devices 8 fixed on the first fixing support 10 and fitted with the plurality of clamps 7 respectively. Each regulating device 8 is configured to regulate a distance between the clamp 7 fitted with it and the first fixing support 10, and thus it is convenient to regulate a distance between the sliding wire guide rail 51 and the first fixing support 10 such that the sliding wire guide rail 51 can be easily installed.

It should be noted that, as shown in FIG. 15, in some embodiments, when each sub-sliding wire 510 includes the plurality of single-stage sliding contact wires 512, the clamp 7 includes a plurality of clamp grooves 70, and each clamp groove 70 is fitted over one single-stage sliding contact wire 512.

Specifically, as shown in FIG. 14, each regulating device 8 includes an installing plate 80, a regulating column 81 and a positioning element 82. The installing plate 80 is configured to have a substantial L shape and includes a first plate 801 and a second plate 802, and the first plate 801 is fixed on a corresponding clamp 7. In some embodiments, the first plate 801 is fixed on the corresponding clamp 7 via a fixing part, such as a screw.

The second plate 802 has a through hole penetrated through the second plate 802 along a thickness direction thereof. The second plate 802 includes a first surface 803 and a second surface 804 opposite to each other. In some embodiments, the through hole has an obround shape so as to improve universality of the regulating device 8.

In some embodiments, a first end of the regulating column 81 is fixed on the first fixing support 10 and the regulating column 81 is placed on the first surface 803. In some embodiments, as shown in FIG. 14, the regulating device 8 further includes a connecting base 84 fixed on the first fixing support 10 via a screw. One end of the regulating column 81 is fixed on the connecting base 84. In one embodiment, the regulating column 81 and the connecting base 84 are integrally formed.

In some embodiments, the positioning element 82 is configured to have a substantial U shape and fitted over the regulating column 81, and two ends of the positioning element 82 pass through the through hole and are fitted with a regulating nut 83 respectively. The regulating nut 83 rests against the second surface 804 so as to position the positioning element 82. When the regulating nut 83 rests against the, second surface 804, the positioning element 82 is fixed on the second plate 802, and thus the regulating column 81 is positioned on the second plate 802 so as to avoid a movement of the regulating, column 81.

The distance between the clamp 7 and the first fixing support 11 is regulated by regulating a length of a portion of the regulating column 81 placed on the first surface 803. As shown in FIG. 14, in some embodiments, the regulating device 8 includes two positioning elements 82 spaced apart from each other. It should be noted that a number of the positioning element 82 is not limited to this and may be determined according to actual needs. Thus, the regulating device 8 according to embodiments of the present disclosure has a simple structure and can be regulated conveniently.

In some embodiments, as shown in FIG. 13, the expansion and contraction device 6 and the sliding wire guide rail 51 are connected with each other via the clamp 7 and the regulating device 8. The connecting base 84 of the regulating device 8 is fixed on the expansion and contraction device 6, and the clamp 7 is fitted over the sliding wire rail 51. Thus, a distance between the expansion and contraction device 6 and the sliding wire guide rail 51 can be regulated. Meanwhile, by regulating the length of the sliding wire guide rail 51 with the expansion and contraction device 6, the sliding wire guide rail 51 can match with the first chain 24 so as to guarantee that the plurality of vehicle carrying plates 30 can run and charge normally.

In some embodiments, as shown in FIG. 17, the fixing frame 1 includes three frame connecting rods 12, and two ends of each frame connecting rod 12 are connected to the first fixing support 10 and the second fixing support 11 respectively, thus forming a stably fixed structure. In one embodiment, the fixing frame 1 is configured as a steel structure, i.e., the first fixing support 10, the second fixing support 11 and the frame connecting rod 12 are made of steel material.

In some embodiments, as shown in FIG. 17, the fixing frame 1 includes a plurality of strengthening rods 13. Thus, a structural strength of the fixing frame 1 can be improved. In some embodiments, the fixing frame 1 includes six strengthening rods 13, in which two ends of each of two strengthening rods 13 are fixed on the first fixing support 10 and the second fixing support 11, respectively. Middle portions of the two strengthening rods 13 are connected with each other so as to form a substantial X shape. The other four strengthening rods 13 are divided into two groups, and each group includes two strengthening rods 13. First ends of the two strengthening rods 13 of each group are connected with each other and fixed on the frame connecting rod 12, and second ends of the two strengthening rods 13 of each group are fixed on the first fixing support 10 and the second fixing support 11 respectively.

The working process of the three-dimensional circulating garage 100 according to embodiments of the present disclosure will be described in detail hereafter.

1) Storing, and Charging Vehicle

A driver drives the vehicle onto the lowermost vehicle carrying plate 30, and then inserts the charging gun into the charging port of the vehicle. By swiping card or pressing a storing button on the manual operation interface of the controller, the three-dimensional circulating garage 100 is activated, then the vehicle is moved and the charging function of the charger 50 is activated, and thus the vehicle is charged by the charger 50, and also, it is prepared for storing and charging subsequent vehicles.

2) Taking Out Vehicle

By swiping card or pressing a taking out button on the manual operation interface, the three-dimensional circulating garage 100 moves the vehicle carrying plate 30 on which the vehicle to be taken out is placed to the lowermost position and shuts off the charger 50, then the driver pulls the charging gun out of the charging port of the vehicle and puts the charging gun back to a set-down location, and then the driver can drive the vehicle out of the vehicle carrying plate 30 directly.

With the three-dimensional circulating garage 100 according to embodiments of the present disclosure, problems about storing and charging the electric vehicle are solved at the same time.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A three-dimensional circulating garage, comprising:
a fixing frame comprising a first fixing support and a second fixing support spaced apart from and opposed to each other;
a transmission system comprising a transmission device disposed on the fixing frame, and a tray track disposed on at least one of the first fixing support and the second fixing support;
a plurality of tray units, each tray unit comprising:
a tray frame connected with the transmission device and having two rollers disposed on a top thereof, at least one roller of the tray frame being adapted to move in the tray track,
a vehicle carrying plate connected to a lower end of the tray frame and configured to park a vehicle, and
a tray stabilizing beam disposed on the top of the tray frame; and
a driving device connected with the transmission device to drive the transmission device so as to drive the tray unit to move up and down reciprocally in a cyclical manner alone the tray track,
wherein when two adjacent tray units move in a vertical direction, a lower surface of the vehicle carrying plate of an upper tray unit of the two adjacent tray units is supported on the tray stabilizing beam of a lower tray unit of the two adjacent tray units.

2. The three-dimensional circulating garage of claim 1, further comprising a tray positioning device disposed on an upholder and including a positioning arm rotatable between a horizontal position and a vertical position, when the positioning arm rotates to the vertical position, the positioning arm contacts a lower surface of the vehicle carrying plate of a lowermost tray unit so as to play a role of positioning.

3. The three-dimensional circulating garage of claim 2, wherein the tray positioning device further comprises:
a positioning bracket,
two rotation shafts each disposed on and penetrated through the positioning bracket, the positioning arm being disposed on each end of the rotation shaft extended out of the positioning bracket; and
a driving assembly connected with the rotation shaft to drive the rotation shaft to rotate so as to rotate the positioning arm.

4. The three-dimensional circulating garage of claim 3, wherein the driving assembly comprises a first driver, two gear and rack assemblies, a first connecting rod and a second connecting rod, wherein:
each gear and rack assembly comprises a gear and a rack engaged with the gear, the gear is disposed on the rotation shaft, and the rack is disposed on the positioning bracket and horizontally movable;
a first end of the first connecting rod is rotatably disposed on a first end of the second connecting rod via a first rotation, shaft, a second end of the first connecting rod and a second end of the second connecting; rod are rotatably disposed on two racks respectively; and
the first driver is connected to the first rotation shaft so as to drive the first rotation shaft to move between a first position and a second position, when the first rotation shaft moves to the first position, the positioning arm rotates to the vertical position, and when the first rotation shaft moves to the second position, the positioning arm rotates to the horizontal position.

5. The three-dimensional circulating garage of claim 4, wherein the first driver includes a linear actuator, and the linear actuator includes a push rod connected with the first rotation shaft.

6. The three-dimensional circulating garage of claim 4, wherein the tray positioning device further comprises a first sensor to detect whether the first rotation shaft is at the first position, and a second sensor to detect whether a second rotation shaft is at the second position,
wherein the first sensor and the second sensor are connected with the first driver respectively such that the first driver controls the first rotation shaft to move according to detection results of the first sensor and the second sensor.

7. The three-dimensional circulating garage of claim 5, wherein the tray positioning device further comprises a push plate assembly, the push plate assembly comprises a fixing base and a push plate disposed on an upper surface of the fixing base and horizontally movable, the push plate is connected with the push rod, and the first rotation shaft is connected with the push plate.

8. The three-dimensional circulating garage of claim 4, further comprising a manual releasing device connected with the first rotation shaft so as to drive the first rotation to move from the first position to the second position.

9. The three-dimensional circulating garage of claim 8, wherein the manual releasing device comprises a moving rod and a pull cord,
wherein the moving rod is horizontally moveable and has a first end connected with the first rotation shaft; the pull cord has a first end wound on the moving rod and a second end extended out of the positioning bracket.

10. The three-dimensional circulating garage of claim 3, wherein the positioning bracket comprises a first bracket, a second bracket, and two connecting rods spaced apart from each other,
wherein the first bracket and the second bracket are arranged parallel to each other and spaced apart from each other; two ends of each connecting rod are connected with the first bracket and the second bracket respectively, two ends of each rotation shaft are extended out of the first bracket and the second bracket respectively, and the driving assembly is disposed between the first bracket and the second bracket.

11. The three-dimensional circulating garage of claim 1, wherein the driving device comprises a second driver and a first chain wheel driven by the second driver, and the transmission system comprises a driving shaft, two support wheels and two first chains having a ring shape,
wherein a second chain wheel is disposed on each end of the driving shaft, a third chain wheel is disposed on one end of the driving shaft and configured to be engaged with the first chain wheel, the two support wheels are disposed on a side wall of the first fixing support and a side wall of the second fixing support facing to each other respectively, the two first chains are disposed on the first fixing support and the second fixing support respectively, each first chain is disposed on the second chain wheel and the support wheel respectively, a plurality of tray supporting plates are evenly disposed on each first chain, each end of the tray frame of each tray unit is connected with a corresponding tray supporting plate disposed on the first chain.

12. The three-dimensional circulating garage of claim 11, wherein the driving device further comprises a duplex chain wheel, the duplex chain wheel is engaged with the first chain wheel via a second chain, and engaged with the third chain wheel via a third chain.

13. The three-dimensional circulating garage of claim 11, wherein the driving shaft comprises: a shaft body, a first flange plate, a first shaft, a second shaft and a second flange plate;
wherein the first flange plate is disposed on each end of the shaft body, the third chain wheel and one second chain wheel are sleeved on the first shaft, the third chain wheel is fixed on a corresponding first flange plate, the other the second chain wheel is sleeved on the, second shaft, the second flange plate is disposed on one end of the second shaft and fixed on a corresponding first flange plate.

14. The three-dimensional circulating garage of claim 1, further comprising a power supply device connected with each tray unit so as to charge the vehicle placed on the vehicle carrying plate.

15. The three-dimensional circulating garage of claim 14, wherein the power supply device comprises:
a plurality of chargers, each charger being disposed on a corresponding tray frame so as to charge the vehicle placed on the vehicle carrying plate;
a sliding wire guide rail having a ring shape, disposed in a side wall of the first fixing support facing to the second fixing support and configured to connect with an external power supply, and
a plurality of current collectors electrically connected with the sliding wire guide rail and moveable on the sliding wire guide rail,
wherein each current collector is electrically connected with one charger so as to transport electricity collected from the sliding wire guide rail to the charger.

16. The three-dimensional circulating garage of claim 15, wherein the power supply device further comprises a plurality of conductive slip rings, each conductive slip ring comprises a stator and a rotor rotatable with respect to each other, and is connected with one charger, and one current collector corresponding to the charger respectively.

17. The three-dimensional circulating garage of claim 16, wherein each tray frame comprises a tray shaft, the transmission device comprises a plurality of tray supporting plates, one tray supporting plate is sleeved on each end of the tray shaft, the tray shaft is rotatable with respect to the tray supporting plate, the stator is sleeved on the tray shaft and connected to the tray supporting plate, the stator is still with respect to the tray supporting plate, the rotor is sleeved on the tray shaft and still with respect to the tray shaft, a lead-in terminal configured to connect with the power supply is disposed on an end surface of the stator facing to the tray supporting plate, a lead-out terminal configured to connect with the charger is disposed on an end surface of the rotor away from the stator.

18. The three-dimensional circulating garage of claim 15, wherein the sliding wire guide rail comprises a plurality of sub-sliding wires and a plurality of insulation segmentation components, each two adjacent sub-sliding wires are spaced apart from each other and connected with each other via one insulation segmentation component, the sub-sliding wire is configured to connect with the external power supply, the charger is connected with two current collectors, wherein when the tray unit is operating, at least one of the two current collectors corresponding to the charger is electrically connected to the sub-sliding wire.

19. The three-dimensional circulating garage of claim 18, wherein ear sub-sliding wire comprises a plurality of single-stage sliding contact wires, two single-stage sliding contact wires of the plurality of single-stage sliding contact wires are connected with a ground wire and a null line respectively, and other single-stage sliding contact wires of the plurality of single-stage sliding contact wires are connected with a live wire respectively.

20. The three-dimensional circulating garage of claim 15, further comprising an expansion and contraction device disposed on the first fixing support and moveable in an up and down direction, the expansion and contraction device is connected with the sliding wire guide rail so as to drive the sliding wire guide rail to stretch out and draw back when the expansion and contraction device moves along the up and down direction.

21. The three-dimensional circulating garage of claim 20, wherein a support frame is fixed on an upper wall of the first fixing support, a first regulating plate is disposed on an top end of the support frame and defines a threaded hole penetrated the first regulating plate in a thickness direction thereof;
the expansion and contraction device comprises an expansion and contraction frame, a second regulating plate and a regulation fixing element, the expansion and contraction frame is connected with the sliding wire guide rail, a regulating hole having a obtund shape is formed in a lower portion of the expansion and contraction frame, the second regulating plate is disposed on the expansion and contraction frame above the first regulating plate, the regulation fixing element passes through the regulating hole and is fixed on the support frame; and
the three-dimensional circulating garage further comprises a regulating element fitted with the threaded hole, an upper end of the regulating element passes through the threaded hole and rests against a lower surface of the second regulating plate, such that a distance between the first regulating plate and the second regulating plate is regulated by regulating a length of a portion of the regulating element stretched out of the threaded hole.

22. The three-dimensional circulating garage of claim 15, further comprising a plurality of clamps sleeved on the sliding wire guide rail, and a plurality of regulating devices fixed on the first fixing support,
wherein the regulating device is fitted with the clamp one to one and configured to regulate a distance between the clamp fitted therewith and the first fixing support.

23. The three-dimensional circulating garage of claim 22, wherein the regulating device comprises an installing plate configured to have a substantial L shape, a regulating column, and a positioning element configured to have a substantial U shape,
wherein the installing plate comprises a first plate and a second plate, the first plate is fixed on the clamp fitted with the regulating device, the second plate defines a through-hole therein along a thickness direction thereof and comprises a first surface and a second surface opposite to each other, a first end of the regulating column is fixed on the first fixing support, the regulating column is placed on the first surface, the positioning element is sleeved on the regulating column, each end of the positioning element passes through the through-hole and is fitted with a regulating nut, the regulating nut rests against the second surface so as to position the positioning element,
wherein the distance between the clamp and the first fixing support is regulated by regulating a length of a portion of the regulating column placed on the first surface.

24. The three-dimensional circulating garage of claim 23, wherein the through-hole has an obround shape.
